(19) United States
(12) Patent Application Publication
(10) Pub. No.: US 2025/0021676 A1
(43) Pub. Date: Jan. 16, 2025

(54) SYSTEMS AND METHODS FOR PROVIDING CONTENT LEVEL PRIVILEGES

(71) Applicant: Google LLC, Mountain View, CA (US)

(72) Inventors: Radhika Ravindranath, South Plainfield, NJ (US); Benjamin Kaplan, Los Angeles, CA (US); Jacques Mouton, Tampa, FL (US); Frankie Lamar, JR., New York, NY (US); Dev Narendrabhai Patel, Seattle, WA (US)

(21) Appl. No.: 18/222,201

(22) Filed: Jul. 14, 2023

(51) Int. Cl. G06F 21/62

(52) U.S. Cl. CPC G06F 21/6209; G06F 2221/2141

(57) ABSTRACT

A method includes identifying, by a processing device, an object provided in a cloud-based environment. For the object, a first object portion definition and a second object portion definition are generated. The first object portion definition relates to a first portion of the object and the second object portion definition relates to a second portion of the object. A role is associated with the first object portion definition. Responsive to a request of a user associated with the role to access the object, the user is provided with access to the first portion of the object.

### TECHNICAL FIELD

The disclosed implementations relate generally to productivity tools. More particularly, the disclosed implementations relate to methods, systems, graphical user interfaces, and data structures for providing content level privileges.

### BACKGROUND

Cloud computing services allow users to create, edit, share, and collaborate on objects that are stored on the cloud computing service. Users connect to the cloud computing service over a remote network such as the Internet. Objects that can be stored on the cloud computing service include word processing documents, spreadsheets, presentations, images, audio files, video files, and many other types of documents and files. The cloud computing service also provides editing applications for displaying and editing certain objects. These applications can be accessible on a client computer via, for example, a web browser executing on the client computer.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method that identifies, by a processing device, an object provided in a cloud-based environment. For the object, a first object portion definition and a second object portion definition are generated. The first object portion definition relates to a first portion of the object and the second object portion definition relates to a second portion of the object. A role is associated with the first object portion definition. Responsive to a request of a user associated with the role to access the object, the user is provided with access to the first portion of the object and is denied access to the second portion of the object.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture for enabling sub-window interaction, in accordance with implementations of the disclosure.

FIG. 2 is a diagram illustrating an example set of content level privileges, in accordance with one implementation of the present disclosure.

FIG. 3 depicts a flow diagram of a method for a process for generating and assigning a role to a user, in accordance with one implementation of the present disclosure.

FIG. 4 depicts a flow diagram of a method for accessing content related to an object, in accordance with one implementation of the present disclosure.

FIG. 5 depicts a block diagram of an example computing device operating in accordance with one or more aspects of the present disclosure.

### DETAILED DESCRIPTION

Access management tools (also known as identity and access management (IAM) tools) are ubiquitous in today's business environments. Access management tools can include software, such as applications, configured to manage users and their access to certain objects. Access can refer to a user's ability to create, view, modify (e.g., update, comment on, suggest, etc.), share, delete, download, or perform other operations on an object. Objects can refer to structured or unstructured data objects that can be acted upon. For example, an object can include a word processing document, a spreadsheet, a presentation, an image, an audio file, a video file, etc.

In some current systems, there are two types of privileges (assigned permissions granted to a user) related to access management: system level privileges and object level privileges. System level privileges (or administrator privileges) provide a user with access to a network or resources on a network. In particular, system level privileges allow a user to perform actions on an entire system, such as creating or deleting user accounts, installing or uninstalling software, modifying the system's configuration files, etc. Object level privileges allow a user to perform actions on specific objects, such as reading or writing to a file, running a program, etc.

In certain instances, office productivity tools are used by a group of users to collaborate on certain objects. Office productivity tools are applications that allow for the viewing, creating, modifying, sharing and exchanging of various office objects, such as, for example, documents, spreadsheets, memos, presentations, letters, messages, database data, form generation, image editing. An example of this type of application can include an electronic document processing application, where multiple users have access to the same document. These tools can be an extension of features provided by a cloud computing service to a client device and displayed on a web browser, a mobile application, or a desktop application executing on the client device.

In current systems, when a user receives access to an object (e.g., a particular electronic document), the user is able to perform actions on all aspects of the object. For example, if an administrator of an electronic document grants another user (referred to as a collaborator) access to the electronic document, the collaborator can see, modify and/or delete any section of the electronic document. However, in certain scenarios, it is desirable to limit the collaborator's access to certain portions of an object (e.g., of the electronic document). For example, the administrator may desire the collaborator to complete a background section of a business document, without the collaborator having access to certain confidential sections of the document, which is typically not available to users of current systems.

Aspects and implementations of the present disclosure address the above and other deficiencies using a mechanism for providing content level privileges to one or more users of an application. A content level privilege can include privileges that provide a user with access to one or more specific portions of an object. A content level privilege can be based on a definition of a portion of an object (an object portion definition), also referred to as a “scrape expression,” which can include an expression such as a regular expression (regex), a query statement or any other function, command or descriptive statement that causes the portion of the object to be identified or derived. For example, an object portion definition (scrape expression) can include a regex or another statement to derive a particular section(s) of an electronic document (e.g., one or more of the abstract section, the background section, the main body section, the conclusion section, etc.), a clip of an audio file, a clip or chapter of a video file, or any other portions(s) of the object. In another example, an object portion definition (scrape expression) can include a structured query language (SQL) statement to derive a portion of a table. Each scrape expression of an object can be defined using input of an administrator. For example, different scrape expressions of a video file can include statements identifying different points in time within the video (“timestamps”) provided by the administrator or different scrape expressions of an electronic document can include statements identifying different line numbers, page numbers, headers, etc. provided by the administrator. The administrator can further provide input to allow the system to define which users should have access to certain portions of each particular object based on corresponding scrape expressions.

In an illustrative example, an electronic document processing application can be provided by a cloud-based management platform operating in a cloud-based environment. The cloud-based content management platform can enable an administrator of the electronic document to invite other users to join as collaborators with respect to the electronic document. The cloud-based content management platform can further define and assign roles to each collaborator based on input provided by the administrator. A role can include one or more specified content level privileges, system level privileges, and/or object level privileges. For example, three scrape expressions can be defined for an electronic document (e.g., the first scrape expression is related to the first page of the document, the second scrape expression is related to the second page of the document, and the third scrape expression is related to the third page of the document). The administrator can provide first input to define role 1 as including access to the first page and the second page, and provide second input to define role 2 as including access to the first page and the third page. The administrator can then provide additional input to cause role 1 to be assigned to a first collaborator and role 2 to be assigned to a second collaborator. Thus, each collaborator can only have access to particular portions of the electronic document without having access to the unassigned portions. In some implementations, each collaborator may not be shown the existence of object portions to which they do not have access. For example, the collaborator assigned role 2 (access to the first and third page of the electronic document) can see, on the user interface of a client device, only a two-page document (e.g., only first and third page). Thus, the collaborator assigned role 2 can be unaware of the existence of page two of the electronic document.

Aspects of the present disclosure result in improved performance of productivity tools. In particular, the aspects of the present disclosure enable productivity tools to determine which users can access certain content of a particular object, thus allowing the productivity tools to compartmentalize assignments and protect confidential data.

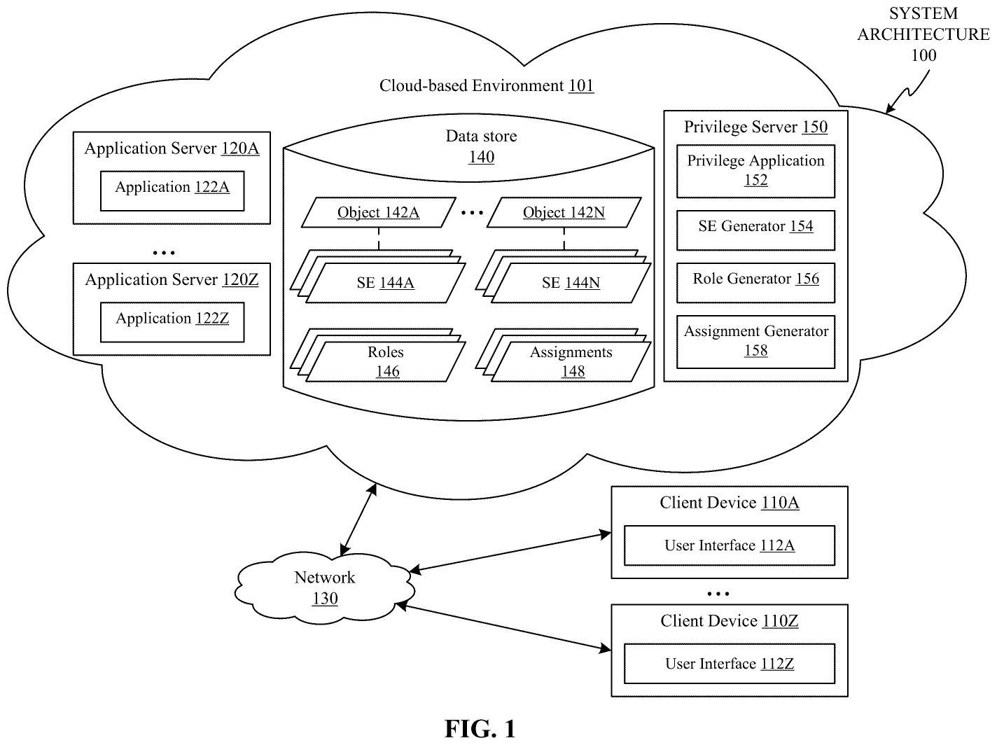

FIG. 1 is an example of a system architecture 100 for enabling compartmentalization of an object via content-based access, in accordance with implementations of the disclosure. The system architecture 100 includes a cloud-based environment 101 connected to client devices 110A-110Z (generally referred to as “client device(s) 110” herein) via a network 130. Although the system architecture 100 is described in the context of a cloud-based environment 101, which can enable communication between application servers 120A-120Z (generally referred to as “server(s) 120” herein) and privilege server 150 in the cloud-based environment 101 and with client devices 110A-110Z over the network 130 to store and share data, it can be understood that the implementations described herein can also apply to systems that are locally interconnected.

In some implementations, the cloud-based environment 101 refers to a collection of physical machines that host applications (e.g., a browser application, an email application, a calendar application, a collaborative database application, a file storage application, word processing application, spreadsheet application, slide presentation application, webpage application, a media item (video items, audio items, etc.) viewing application, etc.) providing one or more services (e.g., web browsing, email, calendar functions, collaborative processing functions, file storage access, word processing, spreadsheet processing, slide generation for inclusion in a slide presentation, webpage processing, video viewing, etc.) to multiple client devices 110A-110Z via the network 130. By way of reference, implementations and examples discussed throughout this disclosure may refer to electronic documents for illustrative purposes. An electronic document can include a word processing document, a spreadsheet document, a slide presentation document, etc. The electronic document can further be a collaborative document (e.g., an electronic document that can be shared with users). The collaborative electronic document can be a collaborative word processing document, a collaborative spreadsheet document, a collaborative slide presentation document, a collaborative webpage document, or any suitable electronic document. However, it should be understood to those skilled in the art that the systems, methods, functions, and implementations of the present disclosure can apply to any type of programs or services offered by any type of host applications.

The network 130 can be a public network (e.g., the Internet), a private network (e.g., a local area network (LAN) or wide area network (WAN)), or a combination thereof. Network 130 can include a wireless infrastructure, which can be provided by one or more wireless communications systems, such as a wireless fidelity (Wi-Fi) hotspot connected with the network 130 or a wireless carrier system that can be implemented using various data processing equipment, communication towers, etc. Additionally or alternatively, network 130 can include a wired infrastructure (e.g., Ethernet).

The cloud-based environment 101 can include one or more application servers 120A-120Z, privilege server 150, and a data store 140. In some implementations, one or more of the application servers 120A-120Z can host an application 122A-122Z (generally referred to as “application 122” herein) that provides a user interface 112A-112Z for presentation on the client devices 110A-110Z. The application server 120A-120Z selected to host the application 122A-122Z can be based on certain load-balancing techniques, service level agreements, performance indicators, or the like. In some implementations, privilege server 150 can host a privilege application 152 that provides a user interface 112A-112Z for presentation on the client devices 110A-110Z. The user interface 112A-112Z can be presented via a web browser (not shown). Alternatively, the client device 110A-110Z includes a local (mobile or desktop) application (not shown) that provides user interface 112A-112Z and communicates with the application 122A-122Z and/or privilege application 152 via network 130.

Application 122A-122Z can generate an object 142A-142N (generally referred to as “object 142” herein), which can be maintained by the respective application 122A-122Z and represented in a user interface 112A-112Z of the application. An object can refer to structured or unstructured data objects than can be acted upon. For example, object 142 can include a word processing document, a spreadsheet, a presentation, an image, an audio file, a video file, etc. In the illustrated example, application 122A-122Z is an electronic document application. Each object 142 (e.g., each word processing document) can include an identifier that can be stored in data store 140. Privilege server 150 can associate each object 142 with one or more scrape expressions 144A, 144N. A scrape expression refers to a definition of a specific portion of an object 142. More specifically, a scrape expression can include an expression such as a regular expression (regex), a query statement or any other function, command or descriptive statement that causes the portion of an object to be identified or derived. A scrape expression can also be referred to as an object portion definition. In some implementations, a scrape expression can be associated with a particular content item (e.g., any data type or data file). For example, a content item can include text, numbers, dates, data tables, videos (or a certain video clip from a video file), audio (or a certain audio clip from an audio file), images, graphs, slides, charts, software programming code, designs, lists, plans, blueprints, maps, etc. Furthermore, a content item can include linked data (e.g., related data from two different objects), rich data (e.g., file attachments, locations, user data), rich entry data (e.g., dropdowns, tags, checkboxes, checklists, status data, etc.), automatic identification numbers, metadata (e.g., create/update time, record author, update author, etc.). Each scrape expression can be created using input of a user (e.g., an administrator with administrative privileges) and stored as scrape expression 144A, 144N, as will be discussed in more detail below. Access to an object portion associated with a corresponding scrape expression 144A, 144N can be referred to as a content level privilege. More specifically, a content level privilege can be a function of one or more scrape expressions created on an object 142.

Roles 146 can include one or more specified content level privileges, system level privileges, and/or object level privileges, which can be created with respective object 142A-142N based on input of a user (e.g., an administrator). In some implementations, system level privileges provide a user with access to the resources of the cloud-based environment 101. In particular, system level privileges allow a user to perform actions related to one or more of application server 120A-120Z, application 122A-122Z, privilege server 150, etc. In some implementations, the actions can relate to creating or deleting user accounts, installing or uninstalling software, modifying configuration files, generating roles 146, generating assignments 148, etc. Object level privileges allow a user to perform actions on specific objects 142. For example, object level privileges can provide a user with access to the entirety of object 142A.

In some implementations, a role 146 can include any combination of specified content level privileges, system level privileges, and/or object level privileges. In one example, a role 146 can include access to object A, and to a first portion of object B and a second portion of object B. The first portion of object B can be associated with scrape expression A and the second portion of object B can be associated with scrape expression B. In another example, a role 146 can include access to all objects 142A-142N stored on data store 140. In yet another example, a role 146 can include access to system A, and to a set of object portions (represented by scrape expressions) from an object related to system B. In certain implementations, a role 146 can further define certain access rights represented by an access control rule. Each access control rule can reflect one or more access rights granted to a particular role with respect to one or more object portions and/or one or more objects represented by one or more corresponding scrape expressions. For example, a role 146 can include the ability for the user to view or comment on a certain object portion, but not provide the ability to modify or delete content from the object portion. In some implementations, each access control rule can be stored on data store 140 in association with a corresponding role 146.

Assignments 148 can specify which user or group of users (e.g., collaborators) are assigned which roles 146. In some implementations, one or more users can be assigned multiple roles 146. In some implementations, a particular role 146 can be assigned to a user or a group of users. By associating a collaborator with a certain role, privilege server 150 can assign, based on administrator input, specific privileges to the collaborator, thereby granting the collaborator access to certain objects 142 and/or portions of the object 142. In some implementations, each assignment includes a record in a data structure (e.g., a metadata table) that correlates a user identification or identifier to a particular role.

An administrator can be a user having system level privileges (also referred to as administrative privileges). As such, an administrator can provide input, via, for example, user interface 112A-112Z, that can be used by privilege server 150 to define scrape expressions 144, roles 146, and assignments 148. For example, privilege server 150 can provide a user interface to allow the administrator to select one or more objects, and identify one or more sections of the object that should be represented by a scrape expression.

Privilege server 150 can include privilege application 152, scrape expression generator 154, role generator 156, and assignment generator 158. Privilege application 152 can provide a user (e.g., an administrator) with tools to generate scrape expressions 144, roles 146, content level privileges, and assignments 148. For example, privilege application 152 can display, via user interface 112A-112Z, one or more systems, one or more objects related to each system, and one or more user interface (UI) toolkits to generate scrape expressions for each object. A UI toolkit can include a collection of features, resources, icons, coding tools, buttons, and so forth for developing computer-based resources and interfaces.

Scrape expression generator 154 can generate one or more scrape expressions 144 for a respective object 142 (e.g., scrape expressions 144A for object 142A). In some implementations, scrape expression generator 154 can generate one or more scrape expressions 144 based on user input. For example, a user can, via user interface 112A-112Z, identify a portion (a clip, a page, a byte, etc.) of an object to designate as a scrape. In some implementations, scrape expression generator 154 can generate one or more scrape expressions automatically. For example, scrape expression generator 154 can generate the scrape expressions 144 based on a predetermined criterion (e.g., each page of a document, each chapter of a video item, etc.).

Role generator 156 can generate one or more roles 146. In some implementations, role generator 156 can generate, modify, and/or delete one or more roles based on user input. For example, a user can, via user interface 112A-112Z, identify which privileges are to be associated with a particular role, which access control rules are to be associated with certain privileges, etc.

Assignment generator 158 can generate one or more assignments 148. In some implementations, assignment generator 158 can assign one or more roles to a user and/or revoke one or more roles from a user based on user input. For example, a user can, via a user interface, identify which roles are to be associated with which users, or which roles are to no longer be associated with a user, as will be discussed in more detail below.

Each user can be associated with an identifier (e.g., user identification (ID)). For example, a user identifier can include a name, a handle, an email address, etc. Each identifier can be related to one or more privileges. For example, the identifier of an administrator can be related to system level privileges, while the identifier of a collaborator of an object can be related to content level privileges (assigned by one or more roles 146). Although aspects of this application will be discussed in relation to users being associated with roles or privileges, it is noted that in some implementations, roles 146 or privileges can be assigned to client devices (e.g., client device 110A-110Z), to software applications configured to execute an automated task, such as a bot or script, and so forth.

In some implementations, the user interface 112A-112Z displays an application view related to an application 122A-122Z and/or privilege application 152. In some implementations, client devices 110A-110Z can concurrently access the application 122A-122Z to review, edit, view, delete, and/or propose changes to one or more one or more scrape expressions of an object 142 based on the role 146 assigned to the user or the client device 110A-110Z.

In some implementations, a user can initiate a session of application 122A-122Z on client device 110A-110Z. A session of the application 122A-122Z can correspond to an application view of an object 142 and can include a sequence of communications between a session start event and a session end event. The session start event can be triggered by the user logging in (e.g., user login) into the application 122A-122Z and selecting the object 142. The session end event can be triggered by the user logging out (e.g., a user logout) from accessing the object 142 of the application 122A-122Z. A user logout can occur automatically (e.g., based on network conditions or lack of user interaction with the application) or in response to a user request. A session state can be represented by the application view of the object 142.

A session can be initiated for newly created objects 142 or an object 142 selected from preexisting sessions. For example, the user can create a new object 142 (e.g., an empty or blank object) or select a previously created object 142 from a list of preexisting objects (e.g., an object having one or more content items). In some implementations, the user can be prompted, by the application user interface 112A-112Z, to input a user identification and/or a password to access an object 142.

In some implementations, a user (e.g., administrator) can share the object 142 with other users (e.g., collaborators). Sharing the object 142 can refer to granting permission to the other users to access the object 142 or portions of the object based on one or more roles 144 assigned to the respective user. Sharing the object 142 can include informing other users via a message (e.g., email, text message, etc.) including a link to the object 142. The content (or scrape expressions) of the object 142 accessible by each user can be based on the roles 146 assigned to each particular user via assignments 148. For example, a user assigned a particular role 146 can be able to open the object 142 and view and/or make changes directly to certain scrape expressions 144 of the object based on the privileges related to the assigned role 146. In some implementations, changes to the scrape expressions 144 can be provided to or presented on client devices 110A-110Z in real-time.

The application servers 120A-120Z and privilege server 150 can be physical machines (e.g., server machines, desktop computers, etc.) that each include one or more processing devices communicatively coupled to memory devices and input/output (I/O) devices. The processing devices can include a computer, microprocessor, logic device or other device or processor that is configured with hardware, firmware, and software to carry out some of the implementations described herein. Each of the application servers 120A-120Z can host application 122A-122N. Privilege server 150 can host privilege application 152.

In some implementations, the user interfaces 112A-112Z can be web pages rendered by a web browser and displayed on the client devices 110A-110Z in a web browser window. In another implementation, the user interfaces 112A-112Z can be included in a stand-alone application downloaded to the client devices 110A-110Z and natively running on the client devices 110A-110Z (also referred to as a “native application” or “native client application” herein).

The client devices 110A-110Z can include one or more processing devices communicatively coupled to memory devices and I/O devices. The client devices 110A-110Z can be desktop computers, laptop computers, tablet computers, mobile phones (e.g., smartphones), or any suitable computing device. The client device 110A-110Z can include components, such as an input device and an output device. A user can be authenticated by the application server 120A-120Z and/or privilege server 150 using a username and password (or other identification information) provided by a user via the user interface 112A-112Z, such that the same client device 110A-110Z can be used by different users at different times.

As discussed above, the client devices 110A-110Z can each include a web browser or a native client application. A user that is invited and becomes a collaborator of an object 142 can request to access the object 142 via the web browser or the native client application. For example, the user can select the object 142 from the user interface 112A-112Z provided by the cloud-based environment 101 and presented by the web browser or the native client application. As such, the client device 110A-110Z associated with the user can request the object from the cloud-based environment 101. The application 122A-122N can provide a user with certain access to one or more objects 142 based on the role(s) assigned to the user.

The application 122A-122Z can also enable users using different client devices 110A-110Z to simultaneously access an object 142 to comment on, edit (e.g., modify or suggest changes), or view content items of the object 142 in a respective user interface 112A-112Z.

In some implementations, as a user edits an object 142 at the client device 110, a change request can be sent to the application server(s) 120. The change request can include a command that can describe the type of change, the location of the change (e.g., coordinate location), and the content of the change, if applicable. In some implementations, the server 120 can receive a change request from client device 110A. The application server 112A can apply the change described by the command in the object 142.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

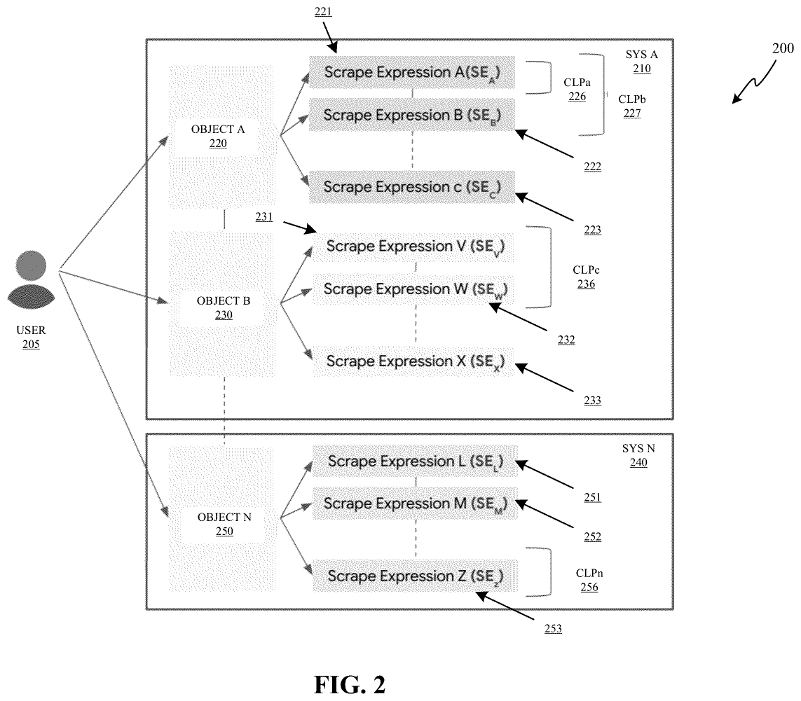

FIG. 2 is a diagram 200 illustrating an example set of content level privileges, in accordance with aspects of the present disclosure. As illustrated, diagram 200 includes system A 210 and system N 240. Each system can be a separate application, server, network, etc. In an illustrative example, system A 210 can be a first type of application (e.g., a word processing application) and system N 240 can be a media viewing application. Each system can include one or more objects A-N 220, 230, 250. For example, system 210 can include object A 220 and object B 230 while system 240 can include object N 250. Each object can be associated with a set of scrape expressions. For example, object A 220 can be associated with scrape expressions A 221, B 222, . . . , C 223. Object B 230 can be associated with scrape expressions V 231, W 232, . . . , X 233. Object C 250 can be associated with scrape expressions L 251, M 252, . . . , Z 253. Certain scrape expressions can be grouped and correspond to a content level privilege. For example, content level privilege A 226 can include scrape expression A 221, content level privilege B 227 can include scrape expressions A 221 and B 222, content level privilege C 236 can include scrape expressions V 231 and W 232, and content level privilege N 256 can include scrape expression Z 253. User 205 can be an administrator with system level privileges (e.g., administrative privileges) to system 210 and system 240. As such, user 205 can manage access to each object A-N 220, 230, 250. User 205 can request to generate a set of scrape expressions for each object (e.g., scrape expressions A-C 221, 222, 223). User 205 can further request to associate certain scrape expressions with respective content level privileges (e.g., scrape expressions A 221 and B 222 can be associated with content level privilege A 226).

In some implementations, user 205 can request to generate one or more roles. As discussed above, a role can include one or more specified content level privileges, system level privileges, and/or object level privileges. In an example, a role (e.g., role A) can allow access to all of the systems (e.g., system A 210, . . . , system N 240). In another example, a role (e.g., role B) can allow access to all of the objects (e.g., system 210 (object A 220, object B 230), . . . , system N 240 (object N 250). In another example, a role (e.g., role C) can allow access to object A (e.g., system 210 (object A 220)) and include content level privilege C (CLPc) 236 (e.g., system 210 (object B 230 (CLPc 236))). In another example, a role (e.g., role D) can include content level privilege C 236 (e.g., system 210 (object B 230 (CLPc 236))) and content level privilege N 256 (e.g., system N 240 (object N 250 (CLPn 256))). In some implementations, access to object portions represented by scrape expressions that are not associated with (labeled as) content level privilege can be automatically included when access is given to an object or system. For example, a role with access to object A 220 provides access rights to object portion represented by scrape expression C 223, but not to object portions represented by scrape expressions A 221 and B 222 (e.g., access to the object portions represented by scrape expressions A 221 and B 222 would need to be expressly provided by the administrator). In some implementations, granting access to an object grants access rights to every object portion represented by a scrape expression associated with the object. In some implementations, a role can be associated with one or more access control rules that provide the ability for the user to perform certain actions on the object, but not others. For example, a role can provide limited (e.g., read only) access to object portions represented by scrape expressions associated with content level privilege A 226, and unlimited access rights (e.g., read, modify, delete, etc.) to the object portion represented by scrape expression 223.

As illustrated, each role can provide access to different portions of an object. This can allow an administrator to request that a collaborative object be compartmentalized and that certain users be restricted from accessing certain portions of an object. For example, the administrator may desire multiple key shareholders to populate certain portions of a Securities and Exchange Commission (SEC) document. However, to protect the current and/or future stock price, the administrator may desire to keep certain portions of the document confidential, and desire to keep the key shareholders from accessing each other's information. Thus, the administrator can manage access to different portions of the document (an object) by providing input to define certain portions of the document using scrape expressions, and requesting that a set of roles be generated to allow access to different portions of the document based on corresponding scrape expressions. The administrator can then request that respective roles be assigned to certain key shareholders to compartmentalize their work on the document.

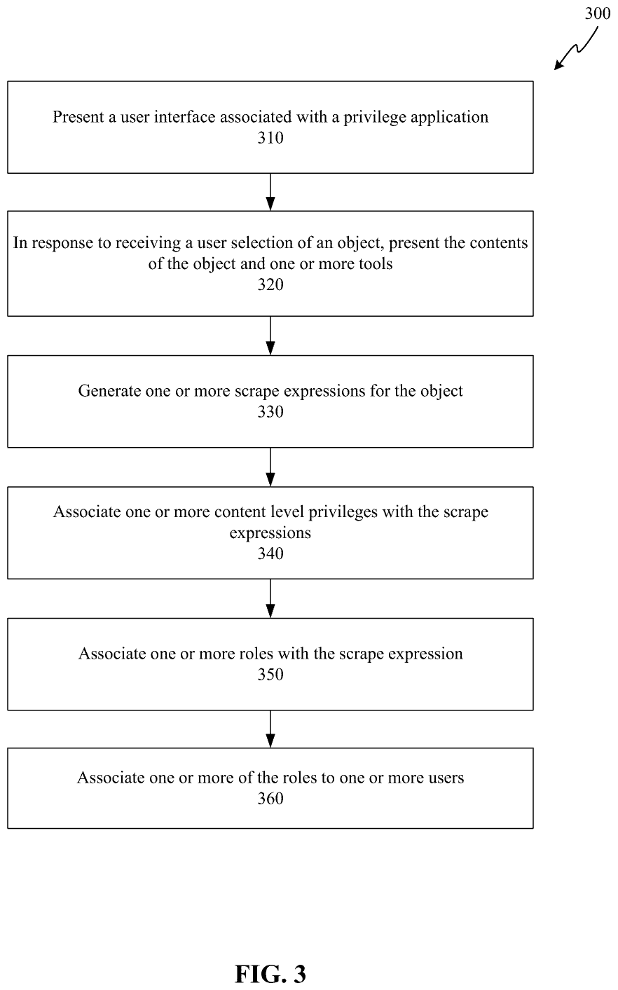

FIG. 3 depicts a flow diagram of a method 300 showing a process for generating and assigning a role to a user, in accordance with some aspects of the disclosure. The method 300 is performed by processing logic that can comprise hardware (circuitry, dedicated logic, etc.), software (such as is run on a general-purpose computer system or a dedicated machine), or a combination of both. In one implementation, the method is performed by the client device 110 and/or the cloud-based environment 101 of FIG. 1, while in some other implementations one or more operations of FIG. 3 can be performed by another machine. In one implementation, a processing device of a privilege server (e.g., privilege server 150 in FIG. 1) performs method 300.

At operations 310, processing logic presents a user interface associated with privilege application 152. The user interface can present one or more systems and/or one or more objects for user selection. In some implementations, in response to a selection of a system (e.g., an application, a server, a network, etc.), the user interface can present one or more objects associated with the selected system. In some implementations, prior to granting access to the user interface, processing logic can determine whether the user or client device requesting access to privilege application 152 is allowed access (e.g., if the user or the client device has administrative privileges). In some implementations, the processing logic can perform a lookup of the user or client device identifier in a database. Responsive to determining that the identifier matches a stored identifier, the processing logic can grant access to privilege application 152.

At operations 320, in response to receiving a user identification or selection of an object, processing logic presents the contents of the object and one or more tools. In some implementations, the one or more tools can include a UI toolkit that includes one or more features, resources, icons, coding tools, and/or buttons to enable the user to request that one or more scrape expressions 144, roles 146, content level privileges, and/or assignments 148 be generated.

At operations 330, processing logic generates one or more object portions definitions (also referred to herein as scrape expressions) for the object. In some implementations, the scrape expressions can be generated based on user input. The processing device can send data related to the scrape expressions for storage on data store 140.

At operations 340, processing logic associates one or more content level privileges with the scrape expressions. In some implementations, the content level privileges can be associated with the scrape expressions based on user input. The processing device can send data related to associations between the content level privileges and the scrape expressions for storage on data store 140.

At operation 350, processing logic associates one or more roles with the scrape expressions. Each role can be a function of one or more content level privileges and/or scrape expressions across one or more objects and/or systems. In particular, each role can include access rights to one or more object portions associated with content level privileges and/or scrape expressions and related to the object (and/or to one or more other objects and/or systems). In some implementations, the roles can be generated based on user input. The processing logic can send data related to the roles for storage on data store 140.

At operation 360, processing logic associates one or more roles to one or more users. In particular, the processing logic can generate one or more assignments, where each assignment can indicate which user is assigned which role(s). In some implementations, the assignments can be generated based on user input. The processing logic can send data related to the assignments for storage on data store 140.

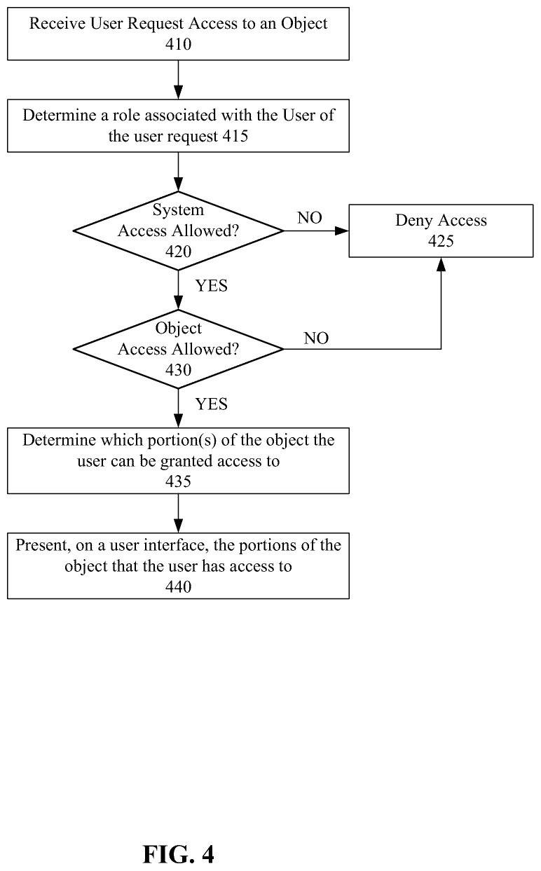

FIG. 4 depicts a flow diagram of a method 400 showing a process for accessing content related to an object, in accordance with some aspects of the disclosure. The method 400 is performed by processing logic that can comprise hardware (circuitry, dedicated logic, etc.), software (such as is run on a general-purpose computer system or a dedicated machine), or a combination of both. In one implementation, the method is performed by the client device 110 and or the cloud-based environment 101 of FIG. 1, while in some other implementations one or more operations of FIG. 4 can be performed by another machine. In some implementations, a processing device of a privilege server (e.g., privilege server 150 in FIG. 1) performs method 400.

At operation 410, processing logic receives a user request to access an object. For example, a user can request access to a collaborative document hosted by application 122A.

At operation 415, processing logic determines a role associated with the user of the user request. For example, processing logic can obtain an identifier related to the user and perform a lookup of the assignments 148 stored on data store 140 to determine which role(s) is associated with the user.

At operation 420, processing logic determines whether the role includes access to the system related to the object (e.g., system level privileges). In response to determining that the role does not include access to the required system level privileges, the processing logic proceeds to operation 425 and denies the user access to the object. In response to determining that the role includes the required system level privileges, the processing logic proceeds to operation 430.

At operation 430, processing logic determines whether the role includes access to the object (e.g., object level privileges). In response to determining that the role does not include access to the object, the processing logic proceeds to operation 425 and denies the user access to the object. In response to determining that the role includes access to the object, the processing logic proceeds to operation 435.

At operation 435, processing logic determines which portion(s) of the object the user can be granted access to. For example, the processing logic can determine which scrape expressions and/or content level privileges are related to the role.

At operation 440, processing logic presents, on a user interface, the portions of the object that the user has access to. For example, in response to determining that the role related to to scrape expressions A and C (but not scrape expression B), the processing logic can display, on the user interface, the portions of the object that are associated with scrape expressions A and C. In some implementations, the processing logic can “black out” or redact the portions of that the objects associated with scrape expressions that are not related to the role (e.g., redact object portion associated with scrape expression B). In some implementations, the processing logic can remove the object portions associated with scrape expressions that are not related to the role. For example, responsive to the role being related to the scrape expressions associated with the first and third page of the electronic document, but not the scrape expression associated with page 2, the processing logic displays a two-page document including only the first and third page. Thus, the user can be unaware of the existence of page two of the electronic document. In some implementations, the processing logic can further provide the user with access rights to the displayed portions. The access right (e.g., modify, comment, delete, etc.) can be determined based on the role.

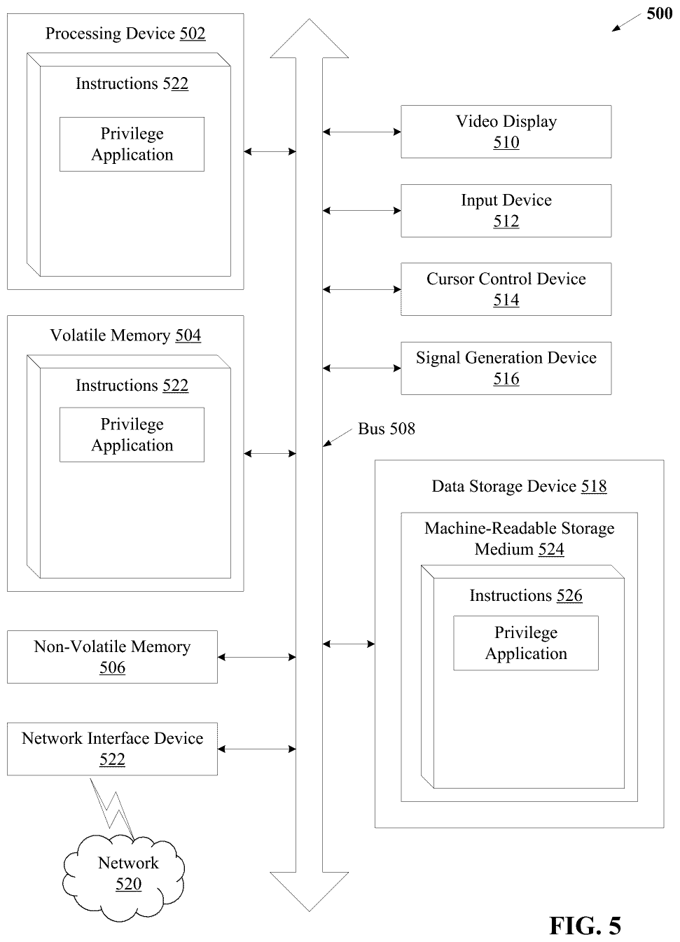

FIG. 5 depicts a block diagram of a computer system operating in accordance with one or more aspects of the present disclosure. In certain implementations, computer system 500 can be connected (e.g., via a network, such as a Local Area Network (LAN), an intranet, an extranet, or the Internet) to other computer systems. Computer system 500 can operate in the capacity of a client device. Computer system 500 can operate in the capacity of a server or a client computer in a client-server environment. Computer system 500 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 can include a processing device 502, a volatile memory 504 (e.g., random access memory (RAM)), a non-volatile memory 506 (e.g., read-only memory (ROM) or electrically-erasable programmable ROM (EEPROM)), and a data storage device 518, which can communicate with each other via a bus 708.

Processing device 502 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 can further include a network interface device 522. Computer system 500 also can include a video display unit 510 (e.g., an LCD), an input device 512 (e.g., a keyboard, an alphanumeric keyboard, a motion sensing input device, touch screen), a cursor control device 514 (e.g., a mouse), and a signal generation device 516.

Data storage device 518 can include a non-transitory machine-readable storage medium 524 on which can store instructions 526 encoding any one or more of the methods or functions described herein, including instructions encoding components of client device of FIG. 1 for implementing methods 300 and 400.

Instructions 526 can also reside, completely or partially, within volatile memory 504 and/or within processing device 502 during execution thereof by computer system 500, hence, volatile memory 504 and processing device 502 can also constitute machine-readable storage media.

While machine-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform methods 400 and 500 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method, comprising:
identifying, by a processing device, an object provided in a cloud-based environment;
generating, for the object, a first object portion definition and a second object portion definition, wherein the first object portion definition relates to a first portion of the object and the second object portion definition relates to a second portion of the object;
associating a role with the first object portion definition; and
responsive to a request of a user associated with the role to access the object, providing the user with access to the first portion of the object while denying the user access to the second portion of the object.

2. The method of claim 1, further comprising generating an access control rule allowing the role to access the first portion of the object.

3. The method of claim 2, wherein the access control rule allows the role to perform, in relation to the first object portion definition, at least one of view the first object portion, modify the first object portion, delete the first object portion, or comment on the first object portion.

4. The method of claim 1, wherein the role is further associated with a third object portion definition that relates to a third portion of another object.

5. The method of claim 1, where the object comprises at least one of a word processing document, a spreadsheet, a presentation, an image, an audio file, or a video file.

6. The method of claim 1, wherein providing the user with access to the first portion of the object further comprises:
receiving, from a client device associated with the user, the user request to access the object;
determining an identifier associated with the user;
determining, based on the identifier, the role associated with the user;
presenting at least a portion of the object on a user interface of the client device; and
providing the user with access to the first portion of the object.

7. The method of claim 6, wherein presenting the at least a portion of the object on the user interface comprises:
determining, based on the identifier, that the role associated with the user prevents access to the second portion of the object; and
preventing display of the second portion of the object on the user interface of the client device.

8. The method of claim 1, wherein the first portion definition is associated with at least one of a regular expression (regex), a query statement, a command, or a descriptive statement that causes the first portion of the object to be identified or derived.

9. The method of claim 1, wherein the first portion definition is defined by another user with administrative privileges to a computer system associated with the object.

10. The method of claim 1, wherein multiple users are associated with the role.

11. The method of claim 1, wherein the object is associated with multiple roles.

12. A system comprising:
a memory; and
a processing device coupled to the memory device, the processing device to perform operations comprising:
identifying an object provided in a cloud-based environment;
generating, for the object, a first object portion definition and a second object portion definition, wherein the first object portion definition relates to a first portion of the object and the second object portion definition relates to a second portion of the object;
associating a role with the first object portion definition; and
responsive to a request of a user associated with the role to access the object, providing the user with access to the first portion of the object while denying the user access to the second portion of the object.

13. The system of claim 12, wherein the operations further comprise:
generating an access control rule allowing the role to access the first portion of the object.

14. The system of claim 13, wherein the access control rule allows the role to perform, in relation to the first object portion definition, at least one of view the first object portion, modify the first object portion, delete the first object portion, or comment on the first object portion.

15. The system of claim 12, wherein the role is further associated with a third object portion definition that relates to a third portion of another object.

16. The system of claim 12, where the object comprises at least one of a word processing document, a spreadsheet, a presentation, an image, an audio file, or a video file.

17. The system of claim 12, wherein providing the user with access to the first portion of the object further comprises:
receiving, from a client device associated with the user, the user request to access the object;
determining an identifier associated with the user;
determining, based on the identifier, the role associated with the user;
presenting at least a portion of the object on a user interface of the client device; and
providing the user with access to the first portion of the object.

18. The system of claim 17, wherein presenting the at least a portion of the object on the user interface comprises:
determining, based on the identifier, that the role associated with the user prevents access to the second portion of the object; and
preventing display of the second portion of the object on the user interface of the client device.

19. The system of claim 13, wherein the first portion definition is associated with at least one of a regular expression (regex), a query statement, a command, or a descriptive statement that causes the first portion of the object to be identified or derived.

20. A non-transitory computer-readable medium comprising instructions that, responsive to execution by a processing device, cause the processing device to perform operations comprising:
identifying an object provided in a cloud-based environment;
generating, for the object, a first object portion definition and a second object portion definition, wherein the first object portion definition relates to a first portion of the object and the second object portion definition relates to a second portion of the object;
associating a role with the first object portion definition; and
responsive to a request of a user associated with the role to access the object, providing the user with access to the first portion of the object while denying the user access to the second portion of the object.
